(19) United States
(12) Patent Application Publication
(10) Pub. No.: US 2019/0041654 A1
(43) Pub. Date: Feb. 7, 2019

(54) Optical Arrangement for Producing White Laser Light from A Plurality of Colored Light Sources

(71) Applicant: Luke Ma, Los Altos, CA (US)

(72) Inventor: Luke Ma, Los Altos, CA (US)

(21) Appl. No.: 16/057,806

(22) Filed: Aug. 7, 2018

Related U.S. Application Data
(60) Provisional application No. 62/541,859, filed on Aug. 7, 2017.

(51) Int. Cl. G02B 27/10; G02B 27/30; G02B 27/09; G02B 5/30; G02B 5/08

(52) U.S. Cl. CPC G02B 27/1006; G02B 27/30; G02B 5/08; G02B 5/30; G02B 27/0955

(57) ABSTRACT

An optical arrangement for producing white laser light from a plurality of colored light sources has a plurality of light emitters, a plurality of dichroic mirrors, a convergence lens, and a collimator lens. The light emitters are laser beam emitters of different colors, which are configured together with the plurality of dichroic mirrors and a plurality of polarizing filters to produce a white light output beam through combination of the directional light beams of the plurality of light emitters. The light emitters' laser beams are combined through the use of the dichroic mirrors to produce a polychromatic light beam, which can be modified through polarizing filters to produce a white light beam.

The current application claims a priority to the U.S. Provisional Patent application Ser. No. 62/541,859 filed on Aug. 7, 2018.

### FIELD OF THE INVENTION

The present invention relates generally to the field of laser projectors. More specifically, the present invention is a method of making a motion white laser projector using multiple light sources.

### BACKGROUND OF THE INVENTION

A laser is a device that emits light through a process of optical amplification based on the stimulated emission of electromagnetic radiation. The term “laser” originated as an acronym for “light amplification by stimulated emission of radiation”. The first laser was built in 1960 by Theodore H. Maiman at Hughes Research Laboratories, based on theoretical work by Charles Hard Townes and Arthur Leonard Schawlow.

A laser differs from other sources of light in that it emits light coherently, spatially and temporally. Spatial coherence allows a laser to be focused to a tight spot, enabling applications such as laser cutting and lithography. Spatial coherence also allows a laser beam to stay narrow over great distances (collimation), enabling applications such as laser pointers. Lasers can also have high temporal coherence, which allows them to emit light with a very narrow spectrum, i.e., they can emit a single color of light. Temporal coherence can be used to produce pulses of light as short as a femtosecond.

Among their many applications, lasers are used in optical disk drives, laser printers, and barcode scanners; DNA sequencing instruments, fiber-optic and free-space optical communication; laser surgery and skin treatments; cutting and welding materials; military and law enforcement devices for marking targets and measuring range and speed; and laser lighting displays in entertainment.

Generally, lasers produce a predominantly coherent light beam, emitting an extremely narrow band of light, typically red, green, or blue. Currently, white laser beams are extremely difficult to create. However, white lasers could have a wide variety of practical applications. At 400 lumens per watt, lasers are far more energy efficient than light-emitting diodes (LEDs) at 150 lumens pet watt. Thus, laser illumination could represent a marked reduction in energy usage. White lasers also produce very vivid colors, which could be used to create laser-based electronic screens such as monitors, which would result in extremely vivid electronic displays. Furthermore, while light-based wireless networks can reach data speeds of 100 gigabits per second, white laser-based wireless networks could be orders of magnitude faster.

It is therefore an objective of the present invention to produce a white laser beam through combination of laser beams of other colors. In this invention is demonstrated a laser projector which produced white lasers by combing the red, green and blue laser beams with precision-controlled intensity ratio from each color of lasers.

### BRIEF DESCRIPTION OF THE DRAWINGS

FIG. 1 is a schematic diagram of a white laser principle demonstration instrument in accordance with the preferred embodiment of the present invention.

FIG. 2 is a schematic diagram of a dichroic mirror combining directional light beams from two light emitters in accordance with the preferred embodiment of the present invention.

FIG. 3 is a schematic diagram of a white laser principle demonstration instrument in accordance with the preferred embodiment of the present invention.

FIG. 4 is a component schematic of a white laser projector build.

FIG. 5 is an illustration of the white laser projector build.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

The present invention presents an apparatus for combining light beams from light sources of multiple different colors in order to create a white light beam. More particularly, the present invention discloses an apparatus for combining multiple different colored laser beams in order to create a white output laser beam.

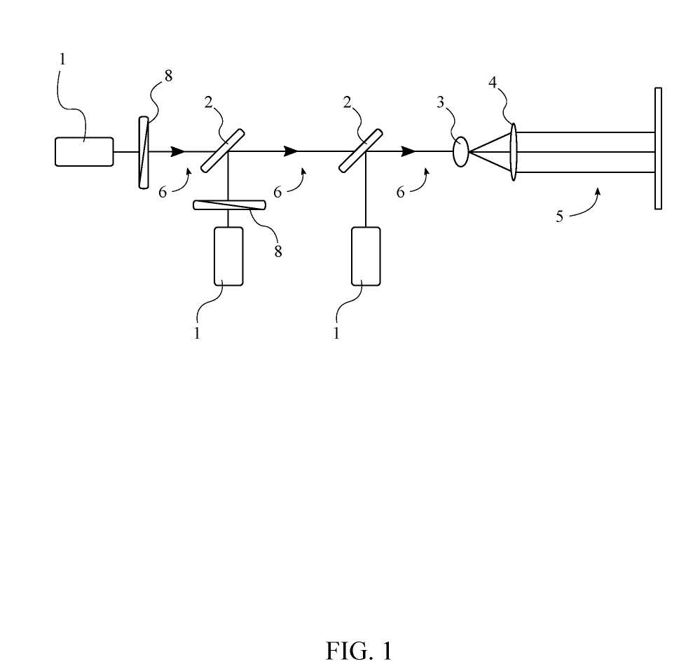

Referring to FIG. 1, in general, the present invention comprises a plurality of light emitters 1, a plurality of dichroic mirrors 2, a convergence lens 3, and a collimator lens 4. Each of the plurality of light emitters 1 is configured to produce a directional light beam of a specified wavelength range. In the preferred embodiment of the present invention, each of the plurality of light emitters 1 is a laser emitter, such as, but not limited to, a superconductor laser emitter. The plurality of light emitters 1 and the plurality of dichroic mirrors 2 are configured and arranged with each other in order to produce a white light output beam 5 through the combination of the directional light beams of the plurality of light emitters 1; more particularly, in order to produce a white laser beam through the combination of multiple laser beams of different wavelength ranges, and thus colors, of the laser light emitters 1.

Each of the plurality of light emitters 1 is positioned and oriented to direct the directional light beam of each of the plurality of light emitters 1 toward one of the dichroic mirrors 2. The plurality of dichroic mirrors 2 is positioned between the plurality of light emitters 1 and the convergence lens 3 along a desired optical path 6, wherein the desired optical path 6 traverses from the plurality of light emitters 1 and through the plurality of dichroic mirrors 2, the convergence lens 3, and finally the collimator lens 4, emitting a final output beam from the collimator lens 4 to be projected on a viewing surface.

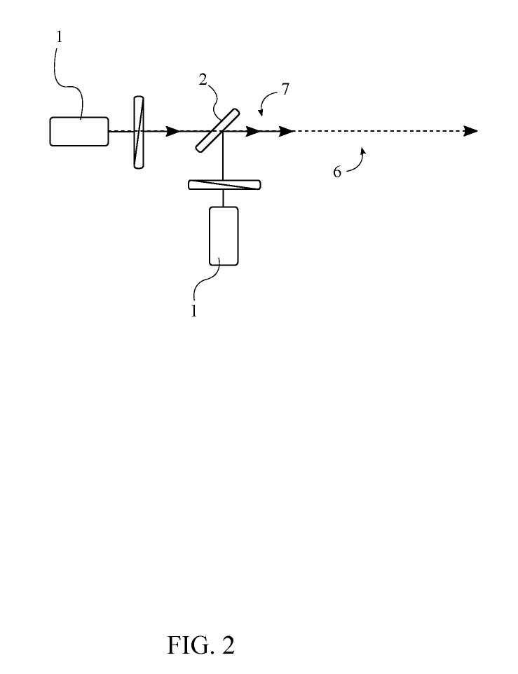

Referring to FIG. 2, each of the plurality of dichroic mirrors 2 is configured to receive the directional light beam of at least two of the plurality of light emitters 1 and reflect a polychromatic output beam 7 along the desired optical path 6, wherein the polychromatic output beam 7 is a combination of the directional light beams of the at least two light emitters 1. The dichroic mirrors 2 act as a beam combiner in order to combine the directional light beams of the light emitters 1. Finally, the convergence lens 3 is positioned between the plurality of dichroic mirrors 2 and the collimator lens 4 along the desired optical path 6.

In the preferred embodiment, each of the plurality of dichroic mirrors 2 is positioned parallel to each other, and oriented at a specified angle to the desired optical path 6. More particularly, each of the plurality of dichroic mirrors 2 is oriented at a 45-degree angle as the specified angle to the desired optical path 6. In other embodiments, the specified angle may vary as desired or applicable. Furthermore, each of the plurality of light emitters 1 is positioned and oriented to direct the directional light beam of each of the plurality of light emitters 1 at the specified angle of 45-degrees in the preferred embodiment to one of the dichroic mirrors 2.

Each of the dichroic mirrors 2 is configured to receive and combine the directional light beam of at least two of the plurality of light emitters 1 and reflect a polychromatic output beam 7 along the desired optical path 6, wherein the polychromatic output beam 7 is a combination of the directional light beams of the at least two light emitters 1.

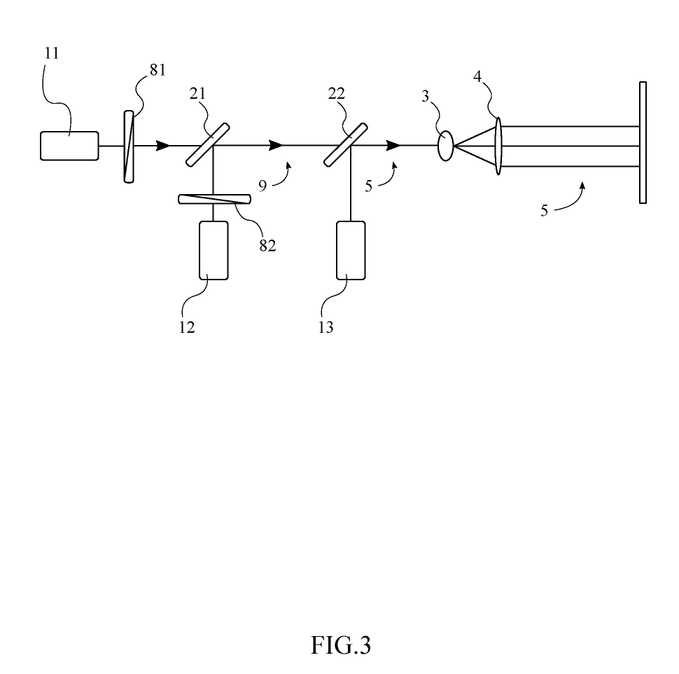

Referring to FIG. 3, in the preferred embodiment, the plurality of light emitters 1 comprises a first light emitter 11, a second light emitter 12, and a third light emitter 13, while the plurality of dichroic mirrors 2 comprises a first dichroic mirror 21 and a second dichroic mirror 22. The first dichroic mirror 21 is configured to transmit the directional light beam of the first light emitter 11 and reflect the directional light beam of the second light emitter 12 in order to produce a first polychromatic light beam 9 along the desired optical path 6, wherein the first polychromatic light beam 9 is a combination of the directional light beam of the first light emitter 11 and the directional light beam of the second light emitter 12. Furthermore, the second dichroic mirror 22 is configured to transmit the first polychromatic light beam 9 and reflect the directional light beam of the third light emitter 13 in order to produce the white light output beam 5, wherein the white light output beam 5 is a combination of the first polychromatic light beam 9 and the directional light beam of the third light emitter 13. Furthermore, in the preferred embodiment, the first light emitter 11 is a red laser emitter, the second light emitter 12 is a green laser emitter, and the third light emitter 13 is a blue laser emitter. In various embodiments, the working wavelength of the red laser emitter is 630-650 nm, the working wavelength of the green laser emitter is 520-532 nm, and the working wavelength of the blue laser emitter is 405-465 nm. It is contemplated, however, that in other embodiments, other colors may be utilized to produce the output white light beam as applicable.

The preferred embodiment of the present invention further comprises a plurality of polarizing optical filters 8, each of the plurality of polarizing optical filters 8 being positioned between one of the plurality of light emitters 1 and one of the plurality of dichroic mirrors 2. More particularly, in the preferred embodiment, the plurality of polarizing optical filters 8 comprises a first polarizing optical filter 81 and a second polarizing optical filter 82. The first polarizing optical filter 81 is positioned between the first light emitter 11 and the first dichroic mirror 21, and the second polarizing optical filter 82 is positioned between the second light emitter 12 and the first dichroic mirror 21. Even more particularly, in the preferred embodiment, the first polarizing optical filter 81 is positioned between the red laser emitter and the first dichroic mirror 21, and the second polarizing optical filter 82 is positioned between the green laser emitter and the first dichroic mirror 21.

An exemplary preferred embodiment of the present invention comprises the first polarizing optical filter 81 and the second polarizing optical filter 82, while the plurality of light emitters 1 comprises the red laser emitter, the green laser emitter, and the blue laser emitter, and the plurality of dichroic mirrors 2 comprises the first dichroic mirror 21 and the second dichroic mirror 22.

The red laser emitter (first light emitter 11) is oriented to direct the directional light beam of the red laser emitter along the desired optical path 6. The first polarizing optical filter 81 is positioned between the red laser emitter 11 and the first dichroic mirror 21. The second polarizing optical filter 82 is positioned between the green laser emitter (second light emitter 12) and the second dichroic mirror 22.

The first dichroic mirror 21 is oriented at a 45-degree angle to the directional light beams of the red laser emitter and the green laser emitter, wherein the red laser emitter and the green laser emitter are oriented perpendicular to each other, and wherein the first dichroic mirror 21 transmits the directional light beam of the red laser emitter and reflects the directional light beam of the green laser emitter in order to produce a first polychromatic light beam.

The second dichroic mirror 22 is oriented at a 45-degree angle to the first polychromatic light beam and the directional light beam of the blue laser emitter, wherein the second dichroic mirror 22 transmits the first polychromatic light beam and reflects the directional light beam of the blue laser emitter in order to produce the white light output beam 5.

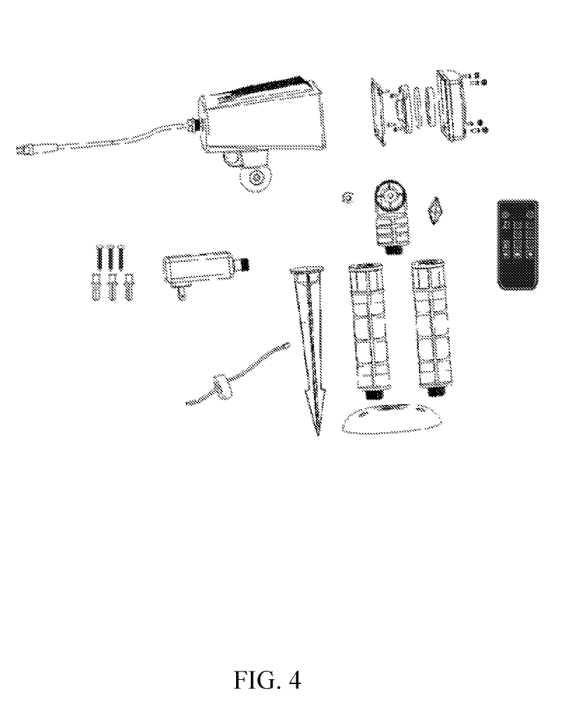

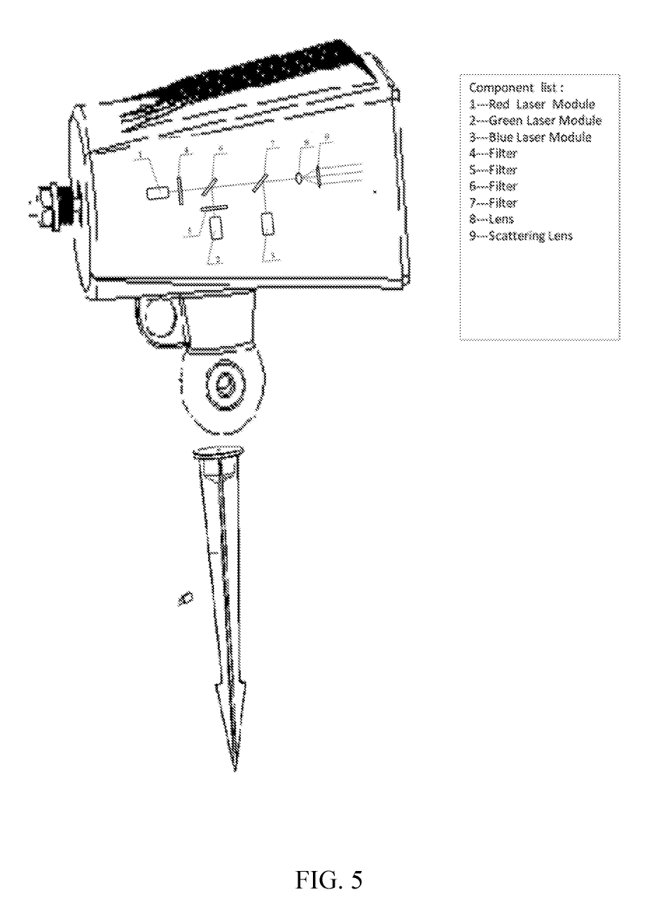

In various embodiments, it may be desirable to adjust the power delivered to the plurality of light emitters 1 in order to adjust the intensity of the directional light beams of the plurality of light emitters 1. Thus, the power delivered to each of the plurality of light emitters 1 may be controlled through an electronic processing device. Further, it may be desirable to specify power ratios between each of the plurality of light emitters 1. For example, the red laser emitter may be supplied with higher power than the green laser emitter. When the proper power ratios are applied to the plurality of light emitters 1 through the present invention, a white laser beam may be observed. Optical designs may be further incorporated to create light projections with hundreds of dots or patterns. FIGS. 4-5 show exemplary diagrams of a full white laser projector build.

A further exemplary disclosure of the present invention is as follows. The utility of the present invention can be achieved by providing a white laser principle demonstrator having the following structure: in the red laser emitter and green laser emitter beam emitted by the optical path, respectively, set the polarizer, the polarized plate after the adjustment of red and green two laser, through a first dichroic mirror, a red and green or green anti-red dichroic mirror combined, and then with the blue laser emitter emitted blue laser beam, through the second dichroic mirror, a red and green anti-blue dichroic mirror, they are bundled as one laser, and then by the objective lens focusing and collimating lens expansion beam, the resulting parallel beam on the gray plate was not the result.

The red laser emitter and the green laser emitter the emitted laser beams are perpendicular to each other, and the first dichroic mirror is arranged at 45° from the optical path. The blue laser beam emitted from the blue laser emitter is perpendicular to the laser beam bundled by the first dichroic mirror, and the red and green anti-blue dichroic mirror is arranged at 45° with the optical path.

The utility model is characterized in that a polarizing plate is placed in the outgoing light path of the red light and the green light for adjusting the intensity of the outgoing light so as to change the intensity ratio of the red, green and blue three-color laser; the utility model is based on the inventive principle is: the laser light is linearly polarized light, and by rotating the optical path set in the polarizer, changing the polarization direction can change the intensity of the polarized light, in order to achieve the purpose of adjusting the ratio of three laser intensity; three laser through a red green or through the green anti-red dichroic mirror and a red and green anti-blue dichroic mirror beam, and then by the objective lens convergence, collimating the lens beam to form a bundle of a certain diameter of the parallel white laser beam, which can be shown on a gray show board or other projecting surface. When the bright, green and blue laser intensity ratio adjustment is appropriate, a white laser beam can be observed. Rotating the polarizers changes the intensity ratio of the three-color laser, and the resulting output laser beam may be observed to be different colors depending on the polarizer rotation. The projector of the present invention is: the use of dichroic mirror beam, to achieve red, green and blue three-way laser beam. Red and green dichroic mirror to the red laser through the high transmittance through the green laser to reflect the high reflectivity, through the red and green anti-blue dichroic mirror to red and green laser with high transmittance through, so that the blue laser to reflect the high reflectivity, through the red and green anti-blue dichroic mirror after three laser beam for the way. If the use of semi-reflective mirror or ordinary beam splitter is used to change the optical path, each beam splitter components will cause the incident optical path to lose half of the light energy; the use of dichroic mirrors can effectively reduce the loss of light energy. At the same time, the use of gray board displays the white laser better relative to a whiteboard display; with a gray board, the white laser and other colors are more easily visible. A motor can further be utilized to control the grating glass with or without patterns to form moving dots or patterns on the display board or projecting surface.

Although the invention has been explained in relation to its preferred embodiment, it is to be understood that many other possible modifications and variations can be made without departing from the spirit and scope of the invention as hereinafter claimed.

What is claimed is:

1. An optical arrangement for producing white laser light from a plurality of colored light sources comprises:
a plurality of light emitters, wherein each of the plurality of light emitters is configured to produce a directional light beam of a specified wavelength range;
a plurality of dichroic mirrors;
a convergence lens;
a collimator lens;
the plurality of light emitters and the plurality of dichroic mirrors being configured to produce a white light output beam through combination of the directional light beams of the plurality of light emitters;
each of the plurality of light emitters being positioned and oriented to direct the directional light beam of each of the plurality of light emitters toward one of the dichroic mirrors;
the plurality of dichroic mirrors being positioned between the plurality of light emitters and the convergence lens along a desired optical path, wherein the desired optical path traverses from the plurality of light emitters and through the plurality of dichroic mirrors, the convergence lens, and the collimator lens;
each of the plurality of dichroic mirrors being configured to receive the directional light beam of at least two of the plurality of light emitters and reflect a polychromatic output beam along the desired optical path,
wherein the polychromatic output beam is a combination of the directional light beams of the at least two light emitters; and
the convergence lens being positioned between the plurality of dichroic mirrors and the collimator lens along the desired optical path.

2. The optical arrangement for producing white laser light from a plurality of colored light as claimed in claim 1 comprises:
each of the plurality of light emitters being a laser emitter.

3. The optical arrangement for producing white laser light from a plurality of colored light as claimed in claim 1 comprises:
each of the plurality of dichroic mirrors being positioned parallel to each other.

4. The optical arrangement for producing white laser light from a plurality of colored light as claimed in claim 1 comprises:
each of the plurality of dichroic mirrors being oriented at a specified angle to the desired optical path.

5. The optical arrangement for producing white laser light from a plurality of colored light as claimed in claim 1 comprises:
each of the plurality of dichroic mirrors being oriented at a 45-degree angle to the desired optical path.

6. The optical arrangement for producing white laser light from a plurality of colored light as claimed in claim 1 comprises:
each of the plurality of light emitters being positioned and oriented to direct the directional light beam of each of the plurality of light emitters at a 45-degree angle to one of the dichroic mirrors.

7. The optical arrangement for producing white laser light from a plurality of colored light as claimed in claim 1 comprises:
each of the plurality of dichroic mirrors being configured to receive and combine the directional light beam of at least two of the plurality of light emitters and reflect a polychromatic output beam along the desired optical path,
wherein the polychromatic output beam is a combination of the directional light beams of the at least two light emitters.

8. The optical arrangement for producing white laser light from a plurality of colored light as claimed in claim 1 comprises:
the plurality of light emitters comprises a first light emitter, a second light emitter, and a third light emitter;
the plurality of dichroic mirrors comprises a first dichroic mirror and a second dichroic mirror;
the first dichroic mirror being configured to transmit the directional light beam of the first light emitter and reflect the directional light beam of the second light emitter in order to produce a first polychromatic light beam along the desired optical path, wherein the first polychromatic light beam is a combination of the directional light beam of the first light emitter and the directional light beam of the second light emitter; and
the second dichroic mirror being configured to transmit the first polychromatic light beam and reflect the directional light beam of the third light emitter in order to produce the white light output beam, wherein the white light output beam is a combination of the first polychromatic light beam and the directional light beam of the third light emitter.

9. The optical arrangement for producing white laser light from a plurality of colored light as claimed in claim 8 comprises:
the first light emitter being a red laser emitter;
the second light emitter being a green laser emitter; and
the third light emitter being a blue laser emitter.

10. The optical arrangement for producing white laser light from a plurality of colored light as claimed in claim 1 comprises:
a plurality of polarizing optical filters; and
each of the plurality of polarizing optical filters being positioned between one of the plurality of light emitters and one of the dichroic mirrors.

11. The optical arrangement for producing white laser light from a plurality of colored light as claimed in claim 10 comprises:
the plurality of polarizing optical filters comprises a first polarizing optical filter and a second polarizing optical filter;
the first polarizing optical filter being positioned between a first light emitter of the plurality of light emitters and a first dichroic mirror of the plurality of dichroic mirrors; and
the second polarizing optical filter being positioned between a second light emitter of the plurality of light emitters and the first dichroic mirror.

12. The optical arrangement for producing white laser light from a plurality of colored light as claimed in claim 1 comprises:
a first polarizing optical filter and a second polarizing optical filter;
the plurality of light emitters comprises a red laser emitter, a green laser emitter, and a blue laser emitter;
the plurality of dichroic mirrors comprises a first dichroic mirror and a second dichroic mirror;
the red laser emitter being oriented to direct the directional light beam of the red laser emitter along the desired optical path;
the first polarizing filter being positioned between the red laser emitter and the first dichroic mirror;
the second polarizing filter being positioned between the green laser emitter and the second dichroic mirror;
the first dichroic mirror being oriented at a 45-degree angle to the directional light beams of the red laser emitter and the green laser emitter,
wherein the red laser emitter and the green laser emitter are oriented perpendicular to each other, and
wherein the first dichroic mirror transmits the directional light beam of the red laser emitter and reflects the directional light beam of the green laser emitter in order to produce a first polychromatic light beam; and
the second dichroic mirror being oriented at a 45-degree angle to the first polychromatic light beam and the directional light beam of the blue laser emitter,
wherein the second dichroic mirror transmits the first polychromatic light beam and reflects the directional light beam of the blue laser emitter in order to produce the white light output beam.
